(19) United States
(12) Patent Application Publication
(10) Pub. No.: US 2006/0119164 A1
(43) Pub. Date: Jun. 8, 2006

(54) Tipping mechanism

(76) Inventor: Keith Clifford Heskin, Oxfordshire (GB)

Correspondence Address: SCHWEGMAN, LUNDBERG, WOESSNER & KLUTH, 121 S. 8TH STREET, SUITE 1600, MINNEAPOLIS, MN, 55402, US

(21) Appl. No.: 10/559,718

(22) PCT Filed: Jun. 4, 2004
(86) PCT No.: PCT/GB04/02402

§ 371 Date: Dec. 6, 2005

(30) Foreign Application Priority Data
Jun. 6, 2003 (GB) 03134118.2

(51) Int. Cl. B60P 1/00

(52) U.S. Cl. 298/1 C

(57) ABSTRACT

tipping mechanism for a skip, especially the skip of a power barrow, is disclosed. A pivoting member is pivotally attached a) to a barrow frame about a first axis, and b) to the skip about a second axis, the second axis extending parallel to and spaced from the first axis. The skip is pivotable about the first axis between a first position, in which its centre of gravity (c.o.g.) is above and at/near the first axis, and a second position, in which the c.o.g. is above and at/near the second axis. The skip is also pivotable about the second axis between the second position and a third position, in which the c.o.g. is forward of the second axis. The skip may pivot from the first to third positions automatically, or by manual initiation, for some or all of the positions, to discharge the skip contents.

The present application relates to a tipping mechanism, particularly but not exclusively for a power barrow.

Wheelbarrows are well known for their use in transporting relatively bulky loads between different locations on a work site, such as a construction site or a domestic property. A wheelbarrow is operated completely manually, with the user himself being required to provide the force to lift the rear end of the wheelbarrow off the ground and to drive the wheelbarrow forwards on its front wheel. In addition, in order to empty the wheelbarrow, the user must force the wheelbarrow to pivot about the front wheel axle by lifting its rear end still further. The rear end needs to be lifted sufficiently high to achieve an angle at which the contents will discharge under the force of gravity.

There are several problems, therefore, with wheelbarrows. Firstly, because a wheelbarrow needs to be driven physically by the user, the maximum load which may be safely transported is relatively small. In addition, a wheelbarrow is difficult to manoeuvre and unload on non-uniform terrains, especially on slopes. Secondly, the single, front wheel results in the wheelbarrow being unstable in use and liable to topple over, especially when cornering. Thirdly, the large tipping height required to empty a wheelbarrow, combined with the single pivot point for this operation, results in use of a wheelbarrow being both labour-intensive and highly hazardous.

A number of attempts to address the problems of wheelbarrows have been made. One type of barrow, which includes an engine for driving a set of front wheels of the barrow, is known as a power barrow. Exemplary prior art power barrows are the Powerwagon™, manufactured by DR® of Vermont, USA, and the Dori Hercule, manufactured by Hancox of Birmingham, UK.

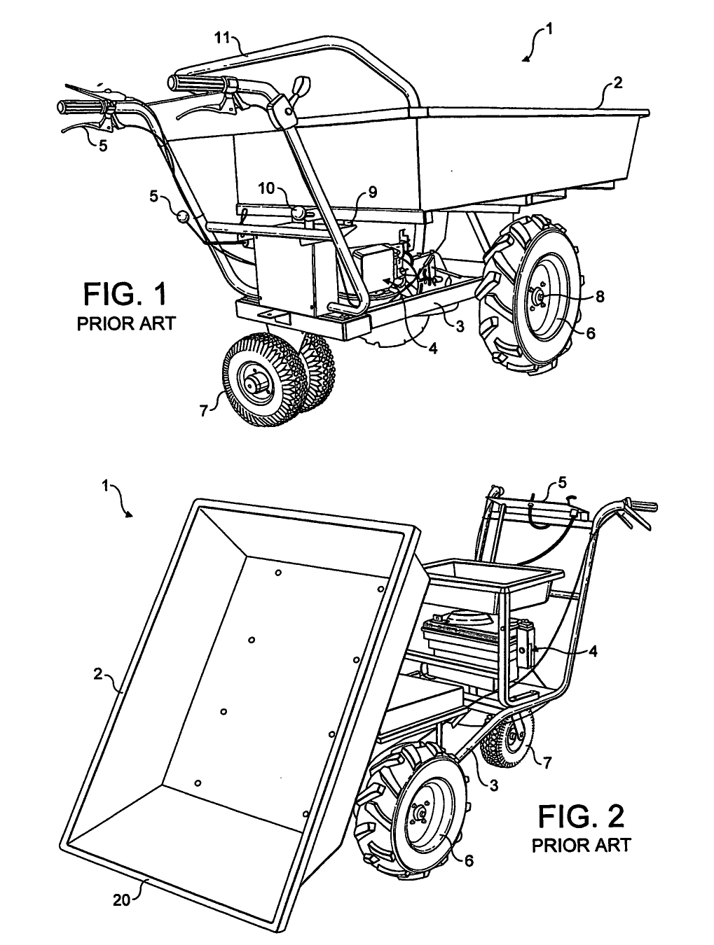

FIG. 1 shows a rear and side view of the Dori Hercule power barrow 1. The Dori Hercule power barrow 1 has a skip 2, also known as a bed, a dump body, or a hopper, for holding the load to be transported. The skip 2 is positioned on a frame 3, to which are mounted the engine 4 and operator controls 5. At a front end of the frame 3, on either side, are the wheels 6 which are driven by the engine 4. Located centrally at the rear end of the frame 3 is a castor wheel 7, or pivoting wheel, which allows the power barrow 1 to be turned. The skip 2 is pivotally-mounted to the frame 3 just above the front wheel axle 8, on either side of the power barrow 1. The rear end of the skip 2 rests on a fixed support 9 and is held in place by a releasable catch or securing pin 10. In order to empty the skip 2, the catch or securing pin 10 needs to be released and the rear end of the skip may need to be physically pushed upwards by the user. This is done by grasping either the rear end of the skip 2 itself or a handle 11 attached to the skip. The skip 2 then pivots about the axis defined by its fixing points with the barrow frame 3. For discharge to take place, the user must either hold the skip 2 in a position suitable for discharging the contents, or continue pushing upwards until the skip tips forward by itself and the front end of the skip comes into contact with a staying bar on the front of the frame 3. At this point, the skip 2 has reached its maximum discharge orientation and is not permitted to pivot further. Typically, however, the skip 2 actually stops tipping forwards by coming into contact with the ground, before reaching the staying bar or skip frame 3.

While the prior art power barrow 1 provides greater stability than the wheelbarrow, particularly when unloading, there are still problems with this type of barrow. Firstly, because compared with the wheelbarrow, the barrow frame 3 remains grounded during unloading, the frame itself prevents the user from being able to stand close to the skip handle 11 while forcing the skip 2 upwards. The user must, therefore, stretch over the rear of the frame 3 or stand to one side of the barrow 1 in order to lift the skip 2 up. In either case, the centre of gravity of the skip 2 moves progressively away from the user as its rear end is lifted during unloading. This means that controlling the skip 2 becomes increasingly difficult as the skip is lifted, especially since the skip may not stop tipping forward until it reaches the ground or a staying bar. This has the effect of making the unloading operation both physically demanding and potentially hazardous. This is especially so on slopes and other uneven terrains.

This problem is addressed in a number of prior art barrows 1 by positioning the centre of gravity of the skip 2 generally above the front wheel axle 8. In this way, less effort is required from the user to tip the skip 2, since once the centre of gravity is moved to a location slightly in front of the front wheel axle 8, the skip will tip forwards by itself. However, in order for the centre of gravity of the skip 2 to be located above the front wheel axle 8, the skip itself must be positioned approximately equally on either side of the axle. As will be understood, if, in this arrangement, the skip 2 rests directly on the frame 3 when transporting loads, the end of the frame forward of the axle 8 will actually obstruct the skip, such that it will not be possible to tip the skip at all. The skip 2 must, therefore, be raised relative to the frame 3, so that tipping is made possible. This, in turn, raises the overall centre of gravity of the power barrow, increasing the risk of the barrow toppling over. To compensate for the reduced stability resulting from raising the skip, the power barrow has to be made wider.

A number of tippers or dumpers employ a hydraulic tipping mechanism to lift the skip and discharge its contents. While this may provide an automated and relatively controlled tipping mechanism, it nevertheless requires the use of a hydraulic ram, a pump, and a reservoir of hydraulic fluid and needs to draw power from the engine to drive it. Such a mechanism would, therefore, undesirably increase the cost, weight and size of a power barrow.

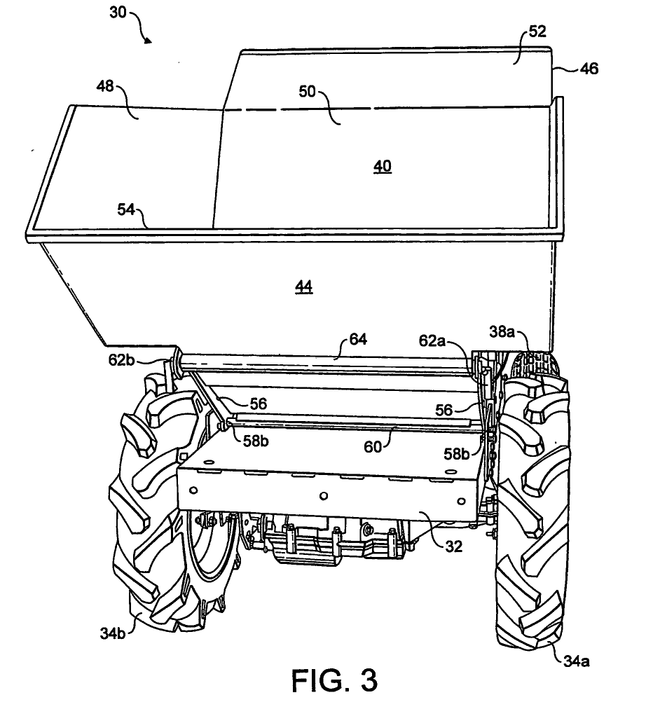

Secondly, in order to ensure full discharge of the contents of the skip, it is normally necessary to tip the skip forwards to its maximum tip orientation, for example until the skip comes to rest against the staying bar or the ground. FIG. 2 shows a front perspective view of the Powerwagon™ in such a position. When the skip is in this position, there is very low clearance between the mouth 20 of the skip and the ground onto which the contents are to be discharged. In addition, the angle the skip 2 makes with the ground is relatively shallow. The point of tipping the skip 2 forwards is so that the contents leave the skip generally by sliding under the force of gravity. The low ground clearance and shallow angle have the effect that a relatively large proportion of the load to be discharged remains in contact with the skip, resting against the skip mouth. Restoring the skip to its normal, load-carrying position is then made difficult, since the discharge now acts as a bulky obstacle. In order to restore the skip to this position, therefore, the power barrow must be moved backwards, away from the discharge. Otherwise, when the skip is pulled back to rest on the frame once again, some of the contents may be left in the skip and further effort from the user will then be required to remove that remainder. Reversing the power barrow to ensure full discharge has the effect of spreading out the discharged load over the ground. The user is then required to sweep or shovel the resulting discharge trail back to the original pile. Either way, the extra effort required from the user is undesirable.

Thirdly, many known power barrows are relatively wide. This means that their use is restricted to site areas which are sufficiently accommodating to allow the barrows to be driven and manoeuvred. In particular, most power barrows are not able to pass through a standard doorway. This means that they may not be driven through a garden gate, for the purpose of moving loads from a front garden to a rear garden in a domestic property, nor may they be driven through the front or back door of a building, in order to transport items into or out of such a building during its construction, for example. As will be understood, simply reducing the width of existing barrows does not provide an acceptable solution to this problem. This is because such a barrow would have a relatively high centre of gravity and narrow base, resulting in an unstable barrow configuration, especially on uneven ground and when cornering.

There is a need, therefore, for a manually-operable tipping mechanism which is less physically demanding to use and which offers a greater degree of control to the user during the tipping operation. There is also a need for a tipping mechanism which affords a relatively low centre of gravity of the skip, so that the risk of a barrow toppling over is reduced, particularly when cornering or on a slope. In addition, it is desirable to have a barrow which is capable of passing through a standard doorway, so that, for example, loads may be transported both into and out of a building. It is also desirable to have a barrow which provides a relatively high ground clearance for the skip mouth, so that the skip may be efficiently emptied.

The present invention aims to address the above objectives by providing an improved tipping mechanism.

According to a first aspect of the present invention, there is provided a tipping mechanism for a skip, comprising a frame; a member, pivotally attached to the frame about a first axis; and a skip, having a centre of gravity, the skip being pivotally attached to the member about a second axis, the second axis extending parallel to and spaced from the first axis, such that the skip is pivotable about the first axis between a first position, in which the first axis is interposed between the centre of gravity and the second axis, and a second position, in which the centre of gravity is interposed between the first and second axes, and is pivotable about the second axis between the second position and a third position, in which the second axis is interposed between the first axis and the centre of gravity. This tipping mechanism is advantageous, because the mechanism provides much greater stability during load transportation and tipping than is offered by prior art barrows. This is particularly so, since, in the prior art barrow, the centre of gravity is significantly raised above the frame. In contrast, the centre of gravity of the skip of the present invention remains relatively close to the frame and, in particular, each of the first and second axes respectively during tipping. In addition, because there are two pivot axes, the skip may be tipped much more safely. This is especially so, since the skip is not permitted to tip forwards without hindrance and with increasing speed until it hits the ground, possibly damaging the skip. Instead, as the skip changes from rotating about the first axis to the second axis, the skip is slowed down very slightly, thereby increasing control of the tipping sequence and reducing the risk of damage to the skip. As will be understood, as the axis of rotation of the skip changes during tipping, the arrangement of the pivot axes and the centre of gravity of the skip may be such that the skip has sufficient angular momentum to take the skip's centre of gravity over the second pivot axis without further effort from the user. In this way, once released, the skip will tip fully forwards by itself, albeit with much greater control and safety. Alternatively, the arrangement may be such that the centre of gravity of the skip in the second position is located in front of the second axis. In this way, it is not essential that the skip attains any particular angular momentum while rotating about the first axis, since the skip would, in fact, tip forwards from the second position even if the skip were momentarily stationary (that is, even if the skip had zero angular momentum) in the second position. Alternatively still, the centre of gravity of the skip, in the second position, may be located to the rear of the second pivot axis in such a way that the skip may be rotated about the first axis from the first position to the second position and stopped. A small amount of effort would then be required of the user to tip the skip forwards towards the third position. Again, once the centre of gravity of the skip passes over the second pivot axis, the skip will continue to tip by itself. It will be readily understood that tipping the skip from the first position to the second position may require user initiation—by arranging the centre of gravity in the first position to the rear of the first pivot axis—or may be automatic—by positioning the centre of gravity in front of the first axis.

Still further, because of the relatively low centre of gravity of the skip, the width of a barrow employing the tipping mechanism may be reduced, without increasing the likelihood of the barrow toppling over during tipping.

Preferably, the first and second axes are the only axes about which the skip pivots with respect to the frame. In this way, the above advantages are provided and only two regions of particular reinforcement, corresponding with the two axes, are required. In addition, tipping of the skip may be effected generally as quickly as with prior art barrows, but sustained effort from the user throughout the tipping sequence is not required.

In a preferred embodiment, the frame has a forward end and the second axis is spaced from the first axis by a distance greater than or equal to a distance between the first axis and the forward end. Preferably, in the second position, the second axis is positioned at or forward of the forward end. This is advantageous, because the forward end of the frame is thereby not permitted to interfere with the skip as the skip is tipped beyond the second position towards the third position.

Preferably, in the first position, the member subtends an acute included angle with the frame. This has the effect that the amount of rotation of the skip required to bring the skip into the second position is small. Were the angle a right angle, or greater than 90°, the amount of rotation required would be relatively large.

Preferably, in the second position, the member rests on the frame. In this way, the weight of the skip is transferred directly to the frame, which then principally bears the load.

In a preferred embodiment, the skip comprises a base and, in the first position, the base rests on the frame. This provides a stable first position of the skip.

Preferably, the skip additionally comprises a tipping face, the tipping face and the base defining an oblique included angle and the tipping face resting on the frame in the second position. This is advantageous, because, while the centre of gravity is located between the first and second axes in the second position, the tipping face provides the stability to the skip to maintain this position, should this arrangement be desired. The oblique angle means that the amount of rotation required to move the skip from the first position to the second position is relatively small.

In a preferred embodiment, in the third position, the skip is not permitted to rotate further about the second axis. Preferably, in the third position, the tipping face of the skip forms a discharge angle with respect to the frame. The advantage of this feature is that the skip may be stayed in the third position so that the skip does not come into contact with the front wheels, thereby allowing a barrow to be moved while tipping. In addition, the skip may be stayed such that the skip does not come into contact with the ground, thereby permitting the discharge to be emptied as fully as possible.

Preferably, the discharge angle is greater than 0° and less than approximately 110°. Preferably still, the discharge angle is 55°. The discharge angle determines whether or not certain, particularly leaden, loads will discharge under the given gravity tip. For loads, such as clay, the discharge angle is preferably greater than 52°, and more preferably greater than 55°.

In a preferred embodiment, the member comprises a first arm and an opposing second arm, the first and second arms being connected by a crosspiece. Preferably, the first axis extends between first and second pivot points disposed on the first and second arms respectively and the second axis extends between third and fourth pivot points disposed on the first and second arms respectively, the first and second pivot points being spaced from the third and fourth pivot points respectively. In this way, the member may cradle the skip in the first and second positions, when the skip and member are in full contact. Increased support is thereby provided to the skip during tipping.

In a preferred embodiment, the base and the tipping face define an interface therebetween and the skip further comprises a bracket disposed along at least a portion of the interface, such that, in the first and second positions, the bracket is disposed substantially coaxially with the first axis. This has the advantage of offering still further support and stability to the skip during tipping.

In a preferred embodiment, the tipping mechanism further comprises a restraining cable or tether connectable between the frame and the skip and adapted to hold the skip at a selected position between the second and third positions. This is particularly advantageous when the skip is not required to tip fully to its maximum, third position to discharge its contents. Furthermore, this overcomes the possibility of the skip coming into contact with the ground when being tipped on a rising slope.

Preferably, the frame and the skip both respectively comprise a plurality of opposing pivot points, such that the location of the first axis may be designated by joining the member to selected first and second ones of the frame pivot points and the location of the second pivot axis may be designated by joining the member to selected third and fourth ones of the skip pivot points. This has the advantage of offering a range of tipping heights for the skip. In addition, the effort required by a user for any particular application may be controlled by appropriate attachment of the skip to the member and the member to the frame.

In a preferred embodiment, there is provided a barrow, comprising the tipping mechanism of the present invention. In this way, the above advantages are provided, offering a user a relatively safer and less demanding barrow.

Preferably, the barrow has a width of less than 735 mm, such that the barrow may pass through a standard doorway. A standard doorway has a width of approximately 735 mm and so a power barrow which could pass between this would preferably have a width of around 720 mm or less. This offers the advantage of being able to transport bulky items into, or out of, a building.

Preferably, the barrow further comprises a plurality of wheels and an engine for driving at least one of the plurality of wheels. The barrow may comprise four directionally-fixed wheels. Since the weight of the skip is borne mainly by the front wheels, one or both of which is preferably driven by the engine, the barrow may readily be turned by sliding or skidding the rear wheels, as appropriate. Alternatively, the barrow further comprises a castor wheel located towards a rear of the barrow. In either case, depending on the terrain of use, the power barrow may reduce the effort required of a user and increase its control generally and, in particular, in terms of manoeuvrability.

Other preferred features are set out in the dependent claims which are appended hereto.

The present invention may be put into practice in a number of ways and some embodiments will now be described, by way of example only, with reference to the following figures, in which:

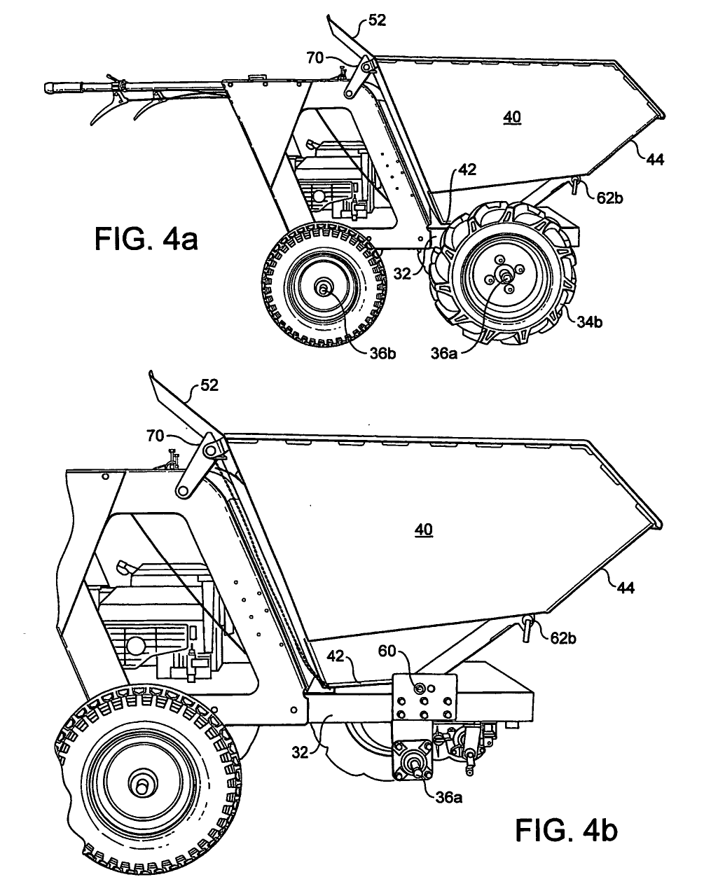

FIG. 3 shows a front view of a power barrow of the present invention;

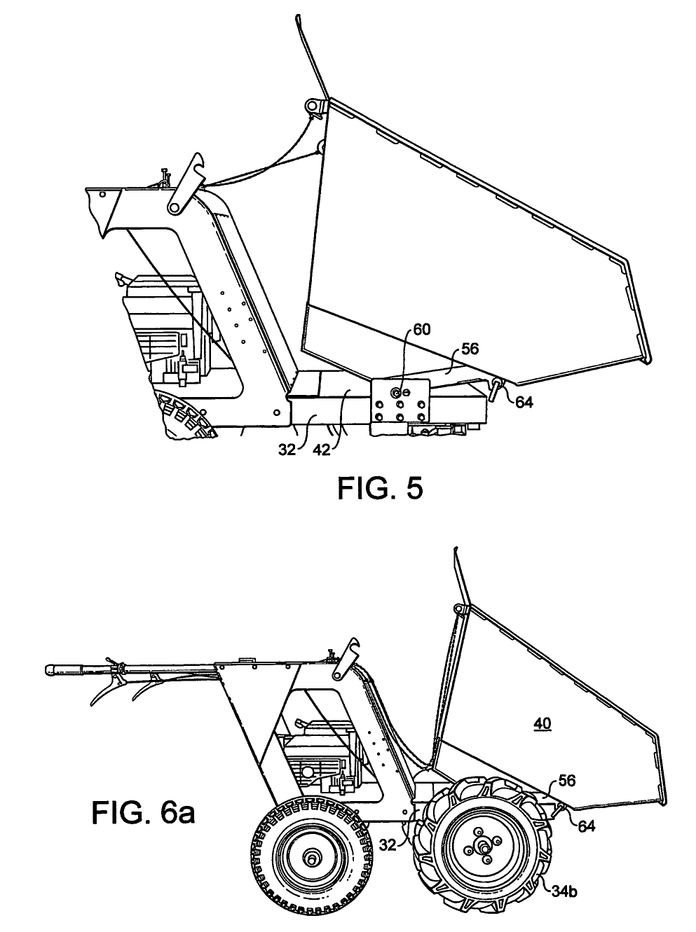

FIGS. 4a and 4b show side views of the power barrow of FIG. 3, with the front right wheel attached and unattached, respectively;

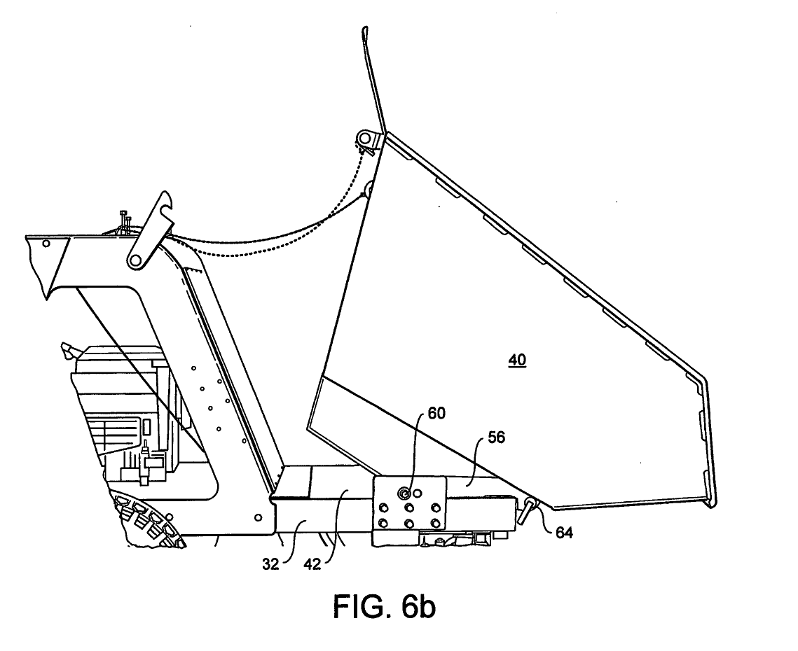

FIG. 5 shows a side view of the power barrow of FIG. 3, between a load-carrying position and an intermediate tipping position;

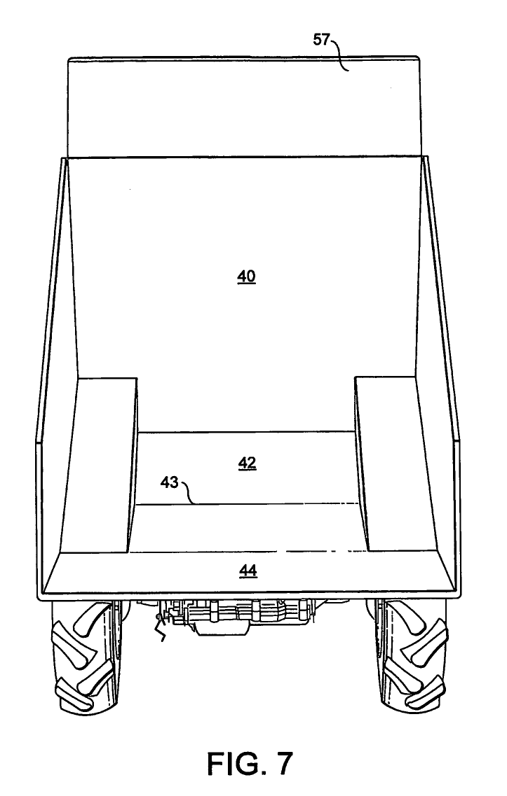

FIGS. 6a and 6b show side views of the power barrow of FIG. 3, in the intermediate tipping position, with the front right wheel attached and unattached, respectively;

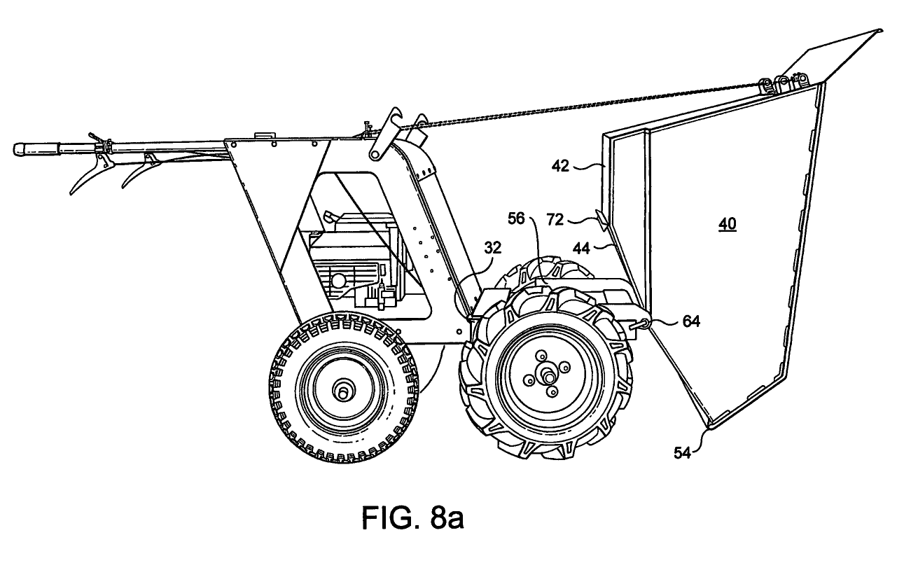

FIG. 7 shows a front view of the power barrow of FIGS. 6a and 6b;

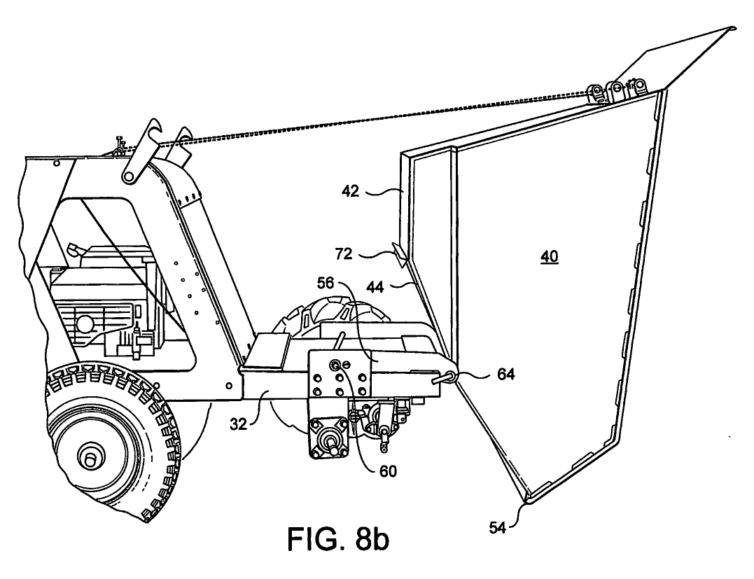

FIGS. 8a and 8b show side views of the power barrow of FIG. 3, in a final tipping position, with the front right wheel attached and unattached, respectively; and

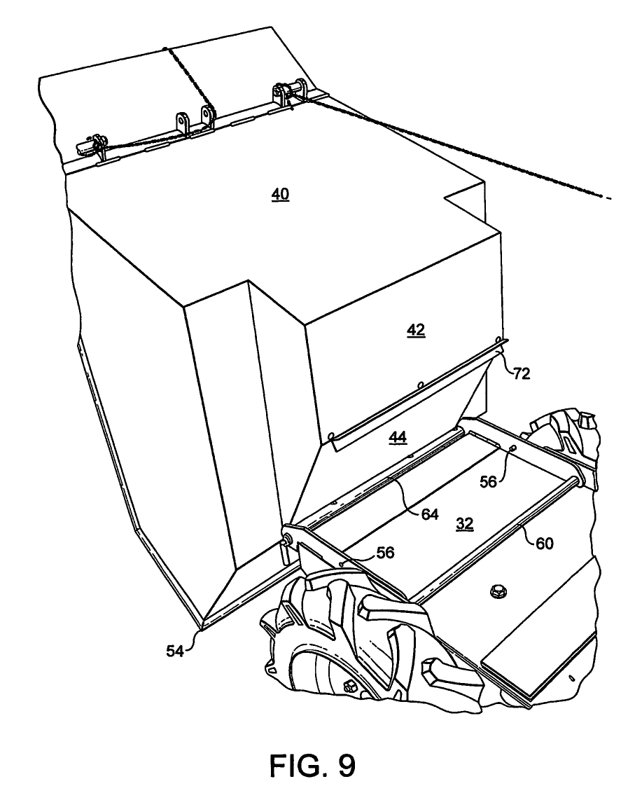

FIG. 9 shows a rear view of the power barrow of FIGS. 8a and 8b.

Referring firstly to FIG. 3, a power barrow 30 according to an embodiment of the present invention is shown. The power barrow 30 includes a frame 32, to which all functional components of the barrow are fixed or mounted. Front wheels 34a,b are mounted to the frame 32 by means of a front axle 36a, and rear wheels 38a,b are mounted to the frame by means of a rear axle 36b. The front wheels 34a,b are the driven wheels of the barrow 30 and the rear wheels 38a,b are free, or coaster, wheels. In certain applications, the barrow 30 may be required to be four-wheel drive, in which case, the rear wheels 38a,b are also driven. The rear axle 36b may be either mounted through the rear of the frame 32 on both sides, or rotatably mounted to the centre of the rear of the frame, to permit directional control of the barrow 30. Alternatively, the rear wheel or wheels 38a,b may consist of one or more castor wheels, thereby affording an even greater degree of directional control to a user.

Disposed on top of the frame 32 is a skip 40, for carrying loads to be transported. The skip 40 consists of a base 42, a tipping face 44, left and right sidewalls 46,48, and a rear wall 50. Fixed to the rear wall 50 of the skip 40 is a handle plate, or bar, 52, which may be employed by the user to lift up the rear end skip as will be described below. The base 42 and tipping face 44 are fixed together, such that an oblique angle is formed at an interface 43 between the two surfaces. This angle may lie anywhere in the range from 90° up to 180°, but is preferably between 140° and 170°, and most preferably approximately 155°, as shown in FIG. 3. The shape of the sidewalls 46,48 corresponds generally to the cross-section formed by the edges of the rear wall 50, the base 42 and the tipping face 44. The top edges of the sidewalls 46,48 are generally parallel to the base 42, except for the forward ends, which slope downwardly. At the forwardmost point of the skip 40, these edges meet the upper rim of the tipping face 44, forming a mouth 54 of the skip.

In a normal, load-carrying position of the skip 40, the base 42 of the skip rests on the frame 32. It may be the entire surface of the base 42, or only a proportion of the base, which is in contact with the frame 32, but the support and stability afforded to the skip 40 is provided by the frame. As will be understood, it is important that the skip 40, along with the barrow 30 as a whole, remains stable at all times, and especially during loading and unloading operations. To this end, a supporting and pivoting member 56 is employed. The member 56 is pivotally joined to both the frame 32 and the skip 40, although the joints are located at different points on the member.

Fixed to the frame 32 are first and second pivot points 58a,b, which are located equally and oppositely on either side of the frame. A first pivot, such as a rod or shaft, runs between these two points 58a,b and defines a first pivot axis 60. Left and right portions of the member 56 are joined to the respective left and right pivot points 58a,b, such that the member may rotate relative to the frame 32, about the first axis 60.

Fixed to the skip 40 are third and fourth pivot points 62a,b, which are located equally and oppositely on either side of the tipping face 44 of the skip. A second pivot, again such as a rod or shaft, runs between these two points 62a,b and defines a second pivot axis 64. Left and right portions of the member 56 are joined to the respective left and right pivot points 62a,b, such that the skip may rotate relative to the member, about the second axis 64. The first and second axes 60,64 are spaced along the member 56 and are parallel to one another. As shown in FIG. 3, the first axis 60 is generally coincident with the interface 43 between the base 42 and the tipping face 44 of the skip 40. The second axis 64 is located at a raised position vertically and nearer to the skip mouth 54, relative to the first axis 60. A forward direction may then be defined as a direction perpendicular to the first and second axes 60,64 and moving from the first axis to the second. In this way, tipping of the skip 40 in the forward direction may be effected in a series of controlled steps.

Referring to FIGS. 4a and 4b, side views of the power barrow 30 of an embodiment of the present invention are shown. For ease of reference, the rear wheels 38a,b and wheel axle 36b are not shown. FIG. 4a shows the barrow with the right front wheel 34b in place and FIG. 4b shows the barrow without this wheel. As shown, the frame 32 of the power barrow 30 includes an engine cover 66, which houses the engine 68. The engine provides power to the front wheels 34a,b, for driving the barrow 30 along and is controlled by operator controls (not shown) on a console mounted to the rear of the engine cover 66, as will be readily understood. For safety reasons, a securing catch 70 is provided on the engine cover 66. The catch 70 engages with a securing bar, or loop, disposed on the rear of the skip 40, so that the skip may be safely locked in position during loading and transporting operations. This is especially important when the centre of gravity of the skip, in the load-carrying position, is located in front of the first axis. In this arrangement, if the securing catch 70 is not engaged, the skip 40 will tip forwards of its own accord, without being physically tipped by the user. Even when the centre of gravity is located behind the first pivot axis 60, it is preferable to employ the catch 70, to ensure that the skip 40 remains in place, for example, when transporting loads on downward slopes.

As shown in this embodiment, the skip 40 includes wheel arches on either side, in order to accommodate the front wheels 34a,b. Of course, depending on the size of the wheels 34a,b, the barrow width, or the skip 40 itself, wheel arches may, or may not, be necessary.

FIG. 4b shows the interface 43 between the base 42 and the tipping face 44 of the skip 40 being generally coaxial with the first pivot axis 60. In addition, the first pivot axis 60 is located generally above the front wheel axle 36a. In this way, a greater part of the load borne by the power barrow 30 is taken over the front wheels 34a,b. This ensures that the barrow 30 is driven with sufficient traction and facilitates manoeuvrability of the barrow, since the rear wheels 38a,b bear relatively less weight than the front wheels 34a,b. This enables the barrow 30 to be turned by skidding or sliding the rear wheels 38a,b. This method of turning the barrow is more preferable than using a castor wheel over rough terrains. This is because a castor wheel has the tendency to turn uncontrollably when encountering bumps and the like, rendering the power barrow generally less controllable.

In this embodiment, the pivot member 56 comprises two generally parallel arms, or lengths, of plate joined by a perpendicular cross-plate. Together, these plates form an approximate ‘H’ shape, although the cross-plate may be disposed anywhere between the two parallel plates (ranging from a ␣ shape to a Π shape). The member 56 is so sized as to cradle the skip 40, when in the load-carrying position shown in FIGS. 4a and 4b. In this position, therefore, the member 56, along with both the first and second pivot axes 60,64, lies adjacent and approximately coplanar with the tipping face 44. While this arrangement is preferable, the member 56 may alternatively comprise two arms, which are independently joined to the frame 32 and the skip 40 on either side. As will be understood, any suitable shape for the member 56 may be employed by the tipping mechanism of the present invention.

The tipping sequence of the power barrow 30 according to this embodiment of the present invention will now be described. After the skip 40 has been loaded with items to be transported and the power barrow 30 has been driven to the required destination for the items, the skip is unloaded as follows. Firstly, the securing catch 70 is moved from its locked position, to allow the skip 40 to be tipped. The skip 40 is then forced to pivot about the first axis 60, either by lifting the handle plate 52 on the rear of the skip in a forward direction, or simply under the force of gravity (in arrangements in which the centre of gravity is initially located in front of the first pivot axis 60). Although the skip 40 itself—and, in particular, the interface 43 between the base 42 and the tipping face 44 of the skip—is not pivotally mounted along the first axis 60, the member 56 is. Since the skip 40 is cradled by the member 56 at this stage, when the rear of the skip is forced forwards, the member is forced to rotate about the first axis 60 to accommodate the rotational movement of the skip. Therefore, in effect, the skip 40 rotates about the first axis 60.

FIG. 5 shows the skip 40 at a specific stage in this first tipping step, between the load-carrying position and an intermediate position (shown in FIGS. 6a, 6b and 7). Here, the weight of the skip 40 (including its contents) is borne principally through the interface 43 between the base 42 and the tipping face 44 of the skip, by the shaft positioned along the first pivot axis 60 between the first and second pivot points 58a,b.

In some prior art barrows 1, such as the Dumperjet and Helpful-S, manufactured by Zallys of Sarcedo, Italy, the single pivot axis of the skip 2 is located towards the front of the skip. The centre of gravity of the skip 2, however, is located generally at its centre.

As described above, in order to empty the contents of the skip 2, a user is required to lift the rear of the skip 2. This is done by applying an upward turning force to the rear of the skip 2. This force must be greater than the downward turning force of the skip 2. This downward force is due to the weight of the skip 2 and the fact that the centre of gravity is located well to the rear of, rather than generally above, the axis of rotation. The greater the distance between the centre of gravity of the skip and the pivot axis, the greater the downward turning force which must be overcome. In the power barrow 30 of the present invention, the centre of gravity of the skip 40 is situated generally directly above or above and near the first pivot axis 60. This has the effect of making the downward turning force due to the weight of the skip 40 much smaller than in the above prior art barrows 1. Accordingly, much less effort in tipping the skip 40 is required from a user, thereby affording much greater control of the tipping operation, which is generally the most hazardous procedure associated with power barrows. This is especially so, since, in some arrangements of the power barrow 30, the centre of gravity of the skip 40 may be initially located to the rear of the first pivot axis 60. In this case, as the skip 40 is tipped forwards by a user, the centre of gravity moves to a point directly above the first pivot axis 60. At this moment, the skip 40 is substantially in equilibrium and the effort required by a user to maintain this state is very low. Only a very small force is then required for the skip 40 to tip forwards to the intermediate position. Of course, the barrow 30 may alternatively be arranged so that the centre of gravity is directly above, or already in front of, the first pivot axis 60, in which case very little, or no, force is required to tip the skip 40 from its initial position.

As the skip 40 is tipped beyond the point shown in FIG. 5, the skip continues to rotate about the first pivot axis 60 until the tipping face 44 comes into contact with a region of the frame 32 forward of the first pivot axis. In fact, since the member 56 cradles a region of the tipping face 44 adjacent the interface 43, it is the member itself which comes into contact with this region of the frame 32 and stops further rotation of the skip 40 about the first pivot axis 60. The skip 40 is then in the intermediate tipping position, as shown in FIGS. 6a, 6b and 7. FIGS. 6a and 6b show side views of the power barrow 30 in the intermediate position, respectively with and without the right front wheel 34b. FIG. 7 shows a front view of the power barrow 30 in this position.

As shown in FIG. 6b, the pivot member 56 is sized so that, when the power barrow 30 is in the intermediate position, the second pivot axis 64 is located adjacent the front end of the frame 32. For the purposes of further tipping of the skip 40, the second pivot axis 64 should be located either substantially directly above, or adjacent and forward of, the end of the frame 32. In this way, the front end of the frame 32 may not interfere with and obstruct the skip 40, as the skip is tipped further forwards from the intermediate position towards a final tipping position. Of course, the second pivot axis 64 is not permanently fixed at this location, since the third and fourth pivot points 62a,b, which define the second axis, join the pivot member 56 and the skip 40 together and clearly move with the skip during tipping operations. The distance between the first and second pivot axes 60,64, therefore, is preferably greater than, or substantially equal to, the distance between the first pivot axis and the front end of the frame 32.

As will be understood from FIG. 7, when the power barrow 30 is in the intermediate position, items may be unloaded from the skip 40 without the need to tip them out onto the ground. This may be especially useful, for example, when transporting many bulky, or delicate, items, which may be damaged if tipped directly onto the ground. On the other hand, this position may be particularly useful when loading the skip 40. For example, using a shovel to load the skip 40 with sand or the like is less difficult when the skip is in the intermediate position, compared with the load-carrying position. This is so, because a user is not required to lift the loaded shovel as high to overcome the mouth 54 of the skip 40. In order for the skip 40 to remain in this position for the purposes of such applications, the power barrow may be arranged so that the centre of gravity of the skip is located in between the first and second pivot axes 36a,b in the intermediate position. Alternatively, if the centre of gravity is arranged to be in front of the second pivot axis 64 in this position, the skip 40 may be physically constrained in the position and secured using a suitable further catch, pin or restraining cable (not shown).

In order to unload the skip 40 under the force of gravity, the skip must tip forwards from the intermediate position, towards the final, tipping position, as shown in FIGS. 8a, 8b and 9. Depending on the particular load being carried, discharge under the force of gravity, also known as a ‘gravity tip’, may start to take place at any point between the intermediate position and the tipping position. From the intermediate position shown in FIG. 6b, the skip 40 is tipped further forwards in the same manner as described above. That is, the handle plate 52 of the skip 40 is forced forwards, causing the skip to rotate. However, in this step, the skip 40 is no longer permitted to rotate about the first pivot axis 60, since the pivot member 56 is in contact with the frame 32 and may not itself be rotated downwards any further. Accordingly, the skip 40 is forced to rotate about the second pivot axis 64. At this point, the centre of gravity of the skip 40 is located above and between the two pivot axes 60,64. That is, in a similar manner to the tipping step from the load-carrying position to the intermediate position described above, the centre of gravity is above and relatively adjacent the second pivot axis 64. This has the effect of making the effort required by a user to tip the skip 40 beyond the intermediate position low. A controlled gravity tip is thereby afforded to the user. As will be understood, if the barrow is arranged with the centre of gravity of the skip 40, in the intermediate position, being located above and in front of the second pivot axis 64, the skip will tip from this position under the force of gravity and without the need for user force.

As the skip 40 is forced beyond the intermediate position, the pivot member 56 is constrained to remain facing the front region of the frame 32. The member 56 is held in place by being joined to the frame 32 at the first and second pivot points 58a,b and by the weight of the skip 40 bearing down on the third and fourth pivot points 62a,b. The region of the tipping face 44, which, up to this point, is cradled by the pivot member 56, is drawn out from between the arms of the member as the skip 40 rotates about the second pivot axis 64. The weight of the skip 40 is thereafter borne by the shaft running between the third and fourth pivot points 62a,b and transmitted to the frame 32 via the pivot member 56.

The skip 40 is tipped forwards and rotates about the second pivot axis 64 towards the final tipping position shown in FIG. 9, until the skip reaches a predetermined, optimum tipping angle. This optimum discharge position is user-selectable and depends on the particular type of load being transported. In this position, the skip 40 is prevented from tipping forwards any further by a restraining cable (not shown). The restraining cable may be of a fixed length, or may be adjustable, depending on how frequently the optimum discharge angle needs to be changed. FIGS. 8a and 8b show the skip 40 at a point of tipping between the intermediate position and the final tipping position. Depending on the type of load being tipped from the skip 40, a lesser or greater tipping angle, relative to a vertical, is required. For example, certain loads, such as clay, will stick to the tipping face 44 and will not be discharged completely unless the tipping angle is greater than 142°, and preferably greater than 145°. Therefore, the final tipping position of the skip 40 preferably has a discharge angle of greater than 145°, although it will be understood that it may not be necessary in all cases for the skip to assume this angle to effect complete discharge.

In order for the contents of the skip 40 to be discharged properly, the mouth 54 of the skip must be clear of the ground. FIG. 9 shows the power barrow 30 in the final tipping position, in which the mouth 54 is spaced from the ground and allows flow-back of the contents under the mouth. This has the effect of increasing the spread of the discharge, thereby reducing the retention of contents within the skip 40 when the skip is restored either to its intermediate position or to its load-carrying position.

The effort required to tip the skip 40 and the ground clearance afforded to the skip in the final tipping position are parameters which are controlled by the design of the power barrow 30. The length of the base 42 of the skip 40 and the angle between the base and the tipping face 44 determine the ease with which the skip may be moved from the load-carrying position to the intermediate position. In combination with this, the distance between the first and second pivot axes 60,64 determines the ease with which the skip 40 may then be moved on towards the final tipping position. Finally, the distance between the second pivot axis 64 and the skip mouth 54 determines the ground clearance of the skip 40. All practical combinations of the above lengths, angles and distances are envisaged and intended to form part of the present invention.

Once the skip 40 has been emptied, the procedure for restoring the skip to its load-carrying position is essentially the reverse of the tipping procedure. That is, the handle plate 52 (or any other suitable region of the skip 40) is forced backwards, so that the skip rotates about the second pivot axis 64. The skip 40 is forced to rotate about this axis 64 until the skip reaches the intermediate position shown in FIGS. 6a, 6b and 7. From this point onwards, further rotation of the skip 40 takes place about the first pivot axis 60. The pivot member 56, along with the second axis 64, is constrained to remain facing the tipping face 44 of the skip 40, as the skip rotates towards the original, load-carrying position, shown in FIGS. 3, 4a and 4b. The skip 40 stops rotating about the first axis 60, once the base 42 comes into contact with the frame 32. At this point, the securing catch 70 may be engaged, to ensure that the skip 40 remains in the load-carrying position.

As shown in FIGS. 8a, 8b and 9, the skip 40 includes a bracket 72, generally disposed along the interface 43 between the base 42 and the tipping face 44. The bracket 72 engages with the shaft running between the first and second pivot points 58a,b when the skip 40 is in the load-carrying position and the intermediate position. The bracket 72 helps to ensure that the skip 40 is positioned properly on the frame 32 and supported effectively by the pivot member 56, during tipping of the skip. The bracket 72 advantageously facilitates rotation of the skip 40 about the first pivot axis 60 and is a preferable feature of the present invention.

Throughout the tipping sequence described above, the centre of gravity of the skip 40 remains relatively low, near to the frame 32 of the power barrow 30. This reduces the amount of effort required by a user to tip the skip 40 forwards. The path described by the centre of gravity of the skip 40, as the skip is moved from the load-carrying position to the final tipping position, is generally a downward curve. As the skip 40 of the present invention is tipped, the likelihood of the power barrow 30 toppling over is, therefore, reduced. Accordingly, as long as the power barrow 30 is already stable before tipping is initiated, the tipping operation itself is a relatively safer procedure than with a number of prior art barrows.

Given the increased stability offered by the power barrow 30 of the present invention, due to its relatively low centre of gravity, the width of the barrow may be reduced without compromising safety. In one embodiment of the present invention, the power barrow 30 is adapted to pass through a standard doorway. The distance between the doorposts of a standard door-frame is approximately 735 mm (29″), so the width of the barrow 30 should be approximately 720 mm (28″), or less, to fit through the opening. Of course, any width for the power barrow 30 may be employed, depending on the desired application of the barrow.

Although the skip. 40 has been described with integral walls 42,44,46,48,50 rigidly joined together, the skip may alternatively comprise detachable walls or panels. This may be advantageous when transporting particularly bulky items, for example. Alternatively still, the skip walls may include hinged panels, which fold or swing down, offering greater access to the skip 40, when in its load-carrying position. The skip 40 may be constructed of any suitable material, such as metal, wood, or plastics.

Although the tipping face 44 has been described as a flat surface, the tipping face may alternatively be angled along a line generally coincident with the second pivot axis 64, when the skip 40 is in the intermediate or final tipping position.

Although the pivots joined to the first and second pivot points 58a,b and the third and fourth pivot points 62a,b have been described as shafts or rods, the pivots may alternatively be formed by individual pivoting joints at each pivot point.

If desired, for example, to slow the skip 40 down even further during the tipping sequence, further pivot axes may be disposed along a line parallel to and spaced between the first and second pivot axes 60,64. This may be in the form of one or more fulcra attached to the frame 32, or by means of an articulated member 56, with the one or more axes located through one or more joints disposed along the member.

For situations in which it is desirable to transport loads with the skip 40 in its intermediate position, a locking pin, or the like, may be provided to secure the skip in place. This may be achieved either by engaging the locking pin through a suitable loop or hole adjacent the interface 43 of the skip 40 and into the frame 32, or by passing the pin through the pivot member 56 and into the loop or hole in the skip. In either case, further forward tipping of the skip 40 is prevented. Although it may not be necessary, rearward movement of the skip 40 may also be prevented by appropriate configuration of the pin and hole.

As described above, a restraining cable is used to hold the skip 40 in an optimum tipping position, at a point between the intermediate and final tipping positions. It may, alternatively, be desirable for the skip 40 to rotate fully to the final position, at which point the skip comes to rest against the front end of the frame 32. Alternatively, a dedicated staying bar, or buffer, may be attached to the front of the frame 32 for this purpose. As will be understood, it is not always necessary to place the skip 40 in the final tipping position to effect full discharge of the contents of the skip. When the discharge angle of the skip 40 is not required to be a maximum (that is, taking up the final tipping position is not necessary for unloading), suitable means for retaining the skip in a conformation between the intermediate position and the final position is provided. The skip 40 may then be stayed in a conformation which provides greater ground clearance. Suitable means for this may be an adjustable tether or restraining cable, attachable to the frame 32 at a location to the rear of the first pivot axis 60 and attachable to either the base 42 or the rear wall 50 of the skip 40, by suitable loops or the like.

Alternatively, the tether may be of fixed length. In this case, there may be provided a plurality of attaching loops disposed sequentially on the frame 32 and a single loop on the base 42 or rear wall 50 of the skip 40. Alternatively still, the tether and loops may be a combination of the above. In any case, the tether is fixed to the desired loops on both the skip 40 and the frame 32, when the skip is stably in the intermediate position. In this way, the skip 40 may be forced to rotate about the second pivot axis 64 only so far as the tether will allow. Once the tether is taut, the skip 40 is held in position while the contents are discharged at the desired angle and ground clearance.

In a further alternative, the tipping face 44 of the skip 40 includes a plurality of pivot points, disposed equally and oppositely on either of the skip. In addition, each arm of the pivot member 56 and both sides of the frame 32 include a corresponding set of pivot points. In this way, the location of the first pivot axis 60 may be selected by joining the rearmost pivot point on each arm of the member 56 to any respective pivot points on the frame 32. Next, the location of the second pivot axis 64 may be selected by joining any of the remaining pivot points on the arms of the member 56 to the corresponding pivot points on the skip 40. Selection of the pivot axes 60,64 is effected by inserting a shaft, or the like, through the appropriate pivot points and securing the joint. Preferably, as described above, the second pivot axis 64 is located substantially coincidentally with, or in front of, the front end of the frame 32. As will be understood, such variable configuration of the pivot axes 60,64 allows the ground clearance of the skip 40 and the ease of tipping to be advantageously controlled by a user.

Finally, in certain situations, it is desirable for a user to have complete control of the skip 40 while discharging its contents. For example, should the user wish to pour wet concrete, control of the flow rate of the concrete out of the skip 40 is required. To this end, telescopic handles (not shown) are attached to one or both sides of the skip 40. The handles are oriented generally parallel to the base 42 of the skip 40. When not in use, the handles are arranged in a retracted conformation. When required, one or both handles may be pulled out by a desired amount and the skip 40 may be tipped in a controlled manner by the user.

1. A tipping mechanism for a skip, comprising:
a frame;
a member, pivotally attached to the frame about a first axis; and
a skip, having a centre of gravity, the skip being pivotally attached to the member about a second axis,
the second axis extending parallel to and spaced from the first axis, such that the skip is pivotable about the first axis between a first position, in which the centre of gravity is located above and at or near the first axis, and a second position, in which the centre of gravity is located above and at or near the second axis, and is pivotable about the second axis between the second position and a third position, in which the centre of gravity is located forward of the second axis.

2. The tipping mechanism of claim 1, wherein, in the first position, the first axis is interposed between the centre of gravity and the second axis.

3. The tipping mechanism of claim 1, wherein, in the first position, the centre of gravity is interposed between the first axis and the second axis.

4. The tipping mechanism of claim 1, wherein, in the second position, the centre of gravity is interposed between the first axis and the second axis.

5. The tipping mechanism of claim 1, wherein, in the second position, the second axis is interposed between the first axis and the centre of gravity.

6. The tipping mechanism of claim 3, wherein the skip is arranged to pivot automatically between the first position and the second position and then automatically between the second position and the third position.

7. The tipping mechanism of claim 2, wherein the skip is arranged to pivot:
a) automatically between a selected one of the first position and the second position or the second position and the third position, and
b) by manual initiation between the other of the first position and the second position or the second position and the third position.

8. The tipping mechanism of claim 2, wherein the skip is arranged to pivot by manual initiation between the first position and the second position and then by manual initiation between the second position and the third position.

9. The tipping mechanism of claim 1, wherein the first and second axes are the only axes about which the skip pivots with respect to the frame.

10. The tipping mechanism of claim 1, wherein the frame has a forward end and the second axis is spaced from the first axis by a distance greater than or equal to a distance between the first axis and the forward end.

11. The tipping mechanism of claim 10, wherein, in the second position, the second axis is positioned at or forward of the forward end.

12. The tipping mechanism of claim 1, wherein, in the first position, the member subtends an acute included angle with the frame.

13. The tipping mechanism of claim 1, wherein, in the second position, the member rests on the frame.

14. The tipping mechanism of claim 1, wherein the skip comprises a base and, in the first position, the base rests on the frame.

15. The tipping mechanism of claim 1, wherein the skip additionally comprises a tipping face, the tipping face and the base defining an oblique included angle and the tipping face resting on the frame in the second position.

16. The tipping mechanism of claim 1, wherein, in the third position, the skip is not permitted to rotate further about the second axis.

17. The tipping mechanism of claim 15, wherein, in the third position, the tipping face of the skip forms a discharge angle with respect to the frame.

18. The tipping mechanism of claim 17, wherein the discharge angle is greater than 0° and less than approximately 110°.

19. The tipping mechanism of claim 17, wherein the discharge angle is 55°.

20. The tipping mechanism of claim 1, wherein the member comprises a first arm and an opposing second arm, the first and second arms being connected by a crosspiece.

21. The tipping mechanism of claim 20, wherein the first axis extends between first and second pivot points disposed on the first and second arms respectively and the second axis extends between third and fourth pivot points disposed on the first and second arms respectively, the first and second pivot points being spaced from the third and fourth pivot points respectively.

22. The tipping mechanism of claim 15, wherein the base and the tipping face define an interface therebetween and the skip further comprises a bracket disposed along at least a portion of the interface, such that, in the first and second positions, the bracket is disposed substantially coaxially with the first axis.

23. The tipping mechanism of claim 1, further comprising a tether connectable between the frame and the skip and adapted to hold the skip at a selected position between the second and third positions.

24. The tipping mechanism of claim 1, wherein the frame and the skip both respectively comprise a plurality of opposing pivot points, such that the location of the first axis may be designated by joining the member to selected first and second ones of the frame pivot points and the location of the second pivot axis may be designated by joining the member to selected third and fourth ones of the skip pivot points.

25. A barrow, comprising the tipping mechanism including:
a frame;
a member, pivotally attached to the frame about a first axis; and
a skip, having a centre of gravity, the skip being pivotally attached to the member about a second axis,
the second axis extending parallel to and spaced from the first axis, such that the skip is pivotable about the first axis between a first position, in which the centre of gravity is located above and at or near the first axis, and a second position, in which the centre of gravity is located above and at or near the second axis, and is pivotable about the second axis between the second position and a third position, in which the centre of gravity is located forward of the second axis.

26. The barrow of claim 25, having a width of less than 735 mm, such that the barrow may pass through a standard doorway.

27. The barrow of claim 25, further comprising a plurality of wheels and an engine for driving at least one of the plurality of wheels.

28. (canceled)

29. The tipping mechanism of claim 16, wherein, in the third position, the tipping face of the skip forms a discharge angle with respect to the frame.
